(19) United States
(12) Patent Application Publication
(10) Pub. No.: US 2013/0100699 A1
(43) Pub. Date: Apr. 25, 2013

(54) DISPLAY DEVICE WITH HEAT DISSIPATING STRUCTURES AND ELECTRONIC DEVICE USING THE SAME

(71) Applicants: Jing-Sian Chen, New Taipei City (TW); Cheng-Hua Tien, New Taipei City (TW); Chih-To Hsieh, New Taipei City (TW); Jyun-Sheng Syu, New Taipei City (TW)

(72) Inventors: Jing-Sian Chen, New Taipei City (TW); Cheng-Hua Tien, New Taipei City (TW); Chih-To Hsieh, New Taipei City (TW); Jyun-Sheng Syu, New Taipei City (TW)

(21) Appl. No.: 13/565,809

(22) Filed: Aug. 3, 2012

(30) Foreign Application Priority Data
Oct. 20, 2011 (TW) 100138146

(51) Int. Cl. F21V 29/00; G09F 13/18

(52) U.S. Cl. 362/611

(57) ABSTRACT

A display device includes a panel, a backlight module, a back cover, a rim frame and a plurality of thermal fins. The backlight module provides the panel with a light source and includes a light emitting unit and a light guide plate. The light emitting unit emits light, and the light guide plate is disposed below the panel for guiding the light emitted by the light emitting unit to the panel. The back cover is installed on an outer side of the panel and the backlight module. The rim frame combines the back cover for covering the panel and the backlight module cooperatively with the back cover. The plurality of thermal fins is disposed on the rim frame for dissipating heat conducted from the rim frame and generated by the light emitting unit.

### BACKGROUND OF THE INVENTION

1. Field of the Invention

The present invention relates to a display device and a related electronic device, and specifically relates to a display device and a related electronic device with thermal fins.

2. Description of the Prior Art

Since liquid crystal is incapable of emitting light, a backlight module is regarded as a key component of a liquid crystal display (LCD) panel. The major function of the backlight module is to provide a light source with sufficient brightness and uniform distribution, so as to make the LCD panel display present images normally. As the LCD panels are applied to many progressing electronics, such as monitors, notebook computers, digital cameras, projectors and so on, demands of the backlight modules and related components thereof are increasing continuously. Generally speaking, the backlight module can be classified into two kinds of designs according to positions of the light source. One is a direct-type backlight module with the light source generated directly below the display panel, and the other is an edge-type backlight module with light source generated from a side of the display panel. The light source generator of the edge-type backlight module is disposed at the side of the display panel, so the size of the LCD panel and manufacturing cost can be reduced, and therefore it can be applied to the electronic product with a small size.

The major mechanism for dissipating heat of the conventional backlight module is to conduct the heat to a back cover and then to dissipate the heat to the environment via a surface of the back cover contacting the outside environment. However, the surface is usually limited to the size of the display panel and affects heat-dissipating efficiency, so that service life and light-emitting efficiency of the backlight module are reduced.

### SUMMARY OF THE INVENTION

The present invention is to provide a display device and a related electronic device with thermal fins to solve above problems.

According to the disclosure, a display device includes a panel, a backlight module, a back cover, a rim frame and a plurality of thermal fins. The backlight module is used for providing the panel with a light source, and the backlight module includes a light emitting unit and a light guide plate. The light emitting unit is used for emitting light. The light guide plate is disposed below the panel and is used for guiding the light emitted by the light emitting unit to the panel. The back cover is installed on an outer side of the panel and the backlight module. The rim frame combines the back cover for covering the panel and the backlight module cooperatively with the back cover. The plurality of thermal fins is disposed on the rim frame for dissipating heat conducted from the rim frame and generated by the light emitting unit.

According to the disclosure, the light emitting unit is coupled to the rim frame and disposed at a side of the light guide plate in a bonding manner.

According to the disclosure, the light emitting unit is disposed on the back cover, and the back cover contacts against the rim frame so that the heat generated by the light emitting unit is conducted from the back cover and the rim frame to the plurality of thermal fins.

According to the disclosure, the light emitting unit is coupled to the back cover in a bonding manner.

According to the disclosure, the back cover is made of metal material.

According to the disclosure, the display device further includes a fixing structure for combining the rim frame and the back cover.

According to the disclosure, the fixing structure includes a first engaging structure, a frame and a second engaging structure. The first engaging structure is formed on the rim frame. The frame is disposed between the back cover and the rim frame. The second engaging structure is disposed on the frame for engaging with the first engaging structure so as to fix the rim frame and the back cover.

According to the disclosure, the rim frame is made of metal material.

According to the disclosure, an electronic device includes a host and a display device. The display device is pivotally connected to the host and the display device includes a panel, a backlight module, a back cover, a rim frame and a plurality of thermal fins. The backlight module is used for providing the panel with a light source, and the backlight module includes a light emitting unit and a light guide plate. The light emitting unit is used for emitting light. The light guide plate is disposed below the panel and is used for guiding the light emitted by the light emitting unit to the panel. The back cover is installed on an outer side of the panel and the backlight module. The rim frame combines the back cover for covering the panel and the backlight module cooperatively with the back cover. The plurality of thermal fins is disposed on the rim frame for dissipating heat conducted from the rim frame and generated by the light emitting unit.

The invention uses the plurality of thermal fins disposed on the rim frame to dissipate the heat generated from the light emitting unit. When the light emitting unit is coupled to the rim frame in a bonding manner, the heat generated from the light emitting unit can be dissipated through the rim frame and the thermal fins to the surrounding environment. In addition, when the light emitting unit is coupled to the back cover in a bonding manner, the back cover of the present invention contacts against the rim frame so that the heat generated from the light emitting unit can be dissipated through the back cover, the rim frame and the thermal fins to the surrounding environment. Therefore, the present invention can enhance the heat-dissipating efficiency so as to increase service life and luminous efficiency of the backlight module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronic device according to an embodiment of the invention.

FIG. 2 is a sectional view of a display device according to the embodiment of the invention.

FIG. 3 is a sectional view of a display device according to another embodiment of the invention.

### DETAILED DESCRIPTION

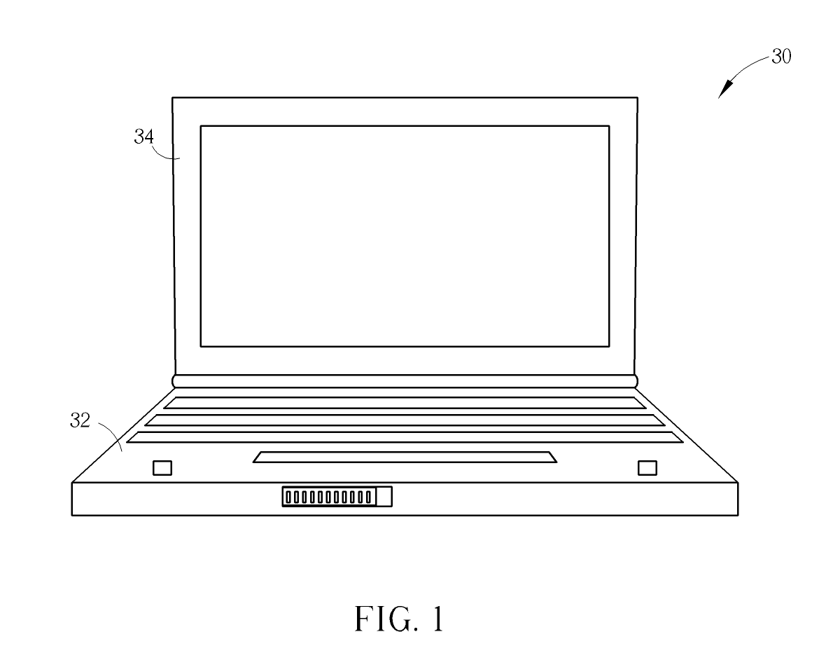

Please refer to FIG. 1. FIG. 1 is a diagram of an electronic device 30 according to an embodiment of the invention. As shown in FIG. 1, the electronic device 30 includes a host 32 and a display device 34. The display device 34 is used for displaying a manipulation screen so that users can manipulate the host 32 to operate desired function according to the manipulation screen. Besides, the display device 34 is pivotally connected to the host 32. Therefore, the display device 34 can expand relative to the host 32 to manipulate, or the display device 34 can fold relative to the host 32 to carry. In this embodiment, the electronic device 30 can preferably be a notebook computer. The host 32 can be a notebook computer host including electronic components, such as a mother board, an optical drive, a hard drive and so on. The display device 34 can be a monitor of the notebook computer, such as a LCD.

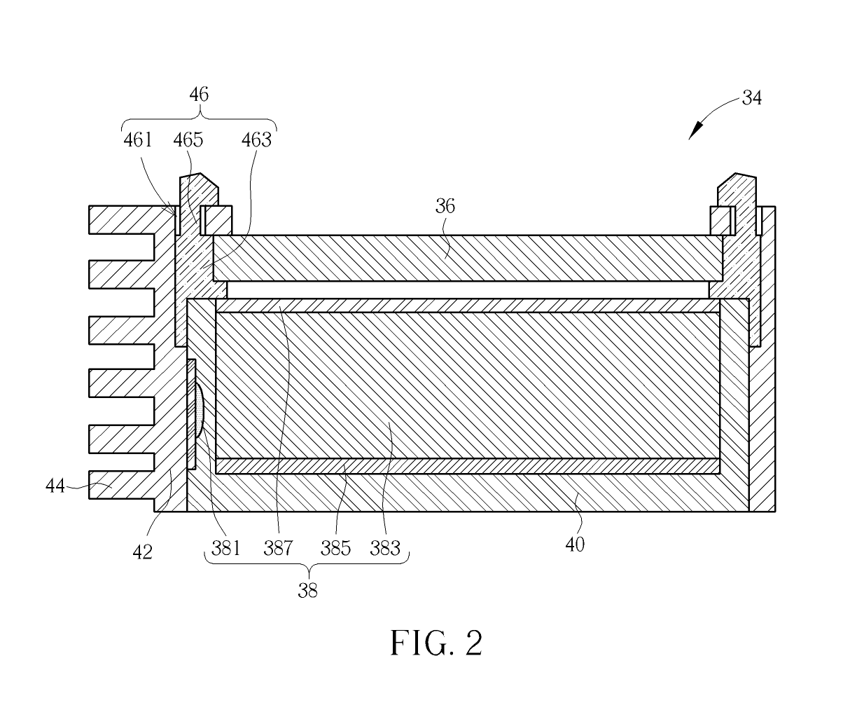

Please refer to FIG. 2. FIG. 2 is a sectional view of the display device 34 according to the embodiment of the invention. As shown in FIG. 2, the display device 34 includes a panel 36, a backlight module 38 and a back cover 40. The panel 36 is for displaying a manipulation screen. The backlight module 38 is disposed below the panel 36 and is used for providing the panel 36 with a light source so that the panel 36 can show the manipulation screen clearly. As a result, users can manipulate the host 32 to operate desired function according to the manipulation screen. The back cover 40 is installed on an outer side of the panel 36 and the backlight module 38, for protecting the panel 36 and the backlight module 38 from being damaged by collision or friction.

Besides, the backlight module 38 includes a light emitting unit 381 and a light guide plate 383. The light emitting unit 381 is used for emitting light, and the light guide plate 383 is disposed below the panel 36. Furthermore, the backlight module 38 can selectively include a reflecting plate 385 and an optical material layer 387. The reflecting plate 385 is disposed below the light guide plate 383. The optical material layer 387 is disposed above the light guide plate 383 and between the light guide plate 383 and the panel 36. The reflecting plate 385 is used for reflecting the light generated from the light emitting unit 381 into the light guide plate 383 so as to increase light utilization rate, for enhancing brightness. The light guide plate 383 is used for guiding the light emitted by the light emitting unit 381 and reflected from the reflecting plate 385 into the panel 36, so as to concentrate the light into the panel. In practical application, the light guide plate 383 can be an acrylic plate. In addition, the optical material layer 387 can mist and focus the light refracted from the light guide plate 383. The optical material layer 387 can include optical materials, such as a prism sheet, for providing the panel 36 with the light in uniformity and larger angle of vision.

In this embodiment, the light emitting unit 381 can be a light emitting diode, and the light emitting unit 381 is disposed at a side of the light guide plate 383. That is, the backlight module 38 can be an edge-type backlight module with the light source from a side of the panel 36. It should be noticed that a position of the light emitting unit 381 is not limited to this embodiment described above. For example, the light emitting unit 381 can be also disposed below the light guide plate 383. That is, the backlight module 38 can be a direct-type backlight module with the light source directly under the panel 36. As for which one is adopted, it depends on practical design demand.

Moreover, the display device 34 further includes a rim frame 42 and a plurality of thermal fins 44. The rim frame 42 combines the back cover 40 for covering the panel 36 and the backlight module 38 cooperatively with the back cover 40. The plurality of thermal fins 44 is disposed on the rim frame 42. In this embodiment, the rim frame 42 and the plurality of thermal fins 44 can be made of metal material, and the rim frame 42 and the plurality of thermal fins 44 can be integrally formed. Furthermore, a circuit of the light emitting unit 381 can be disposed on the rim frame 42 so that the light emitting unit 381 can be coupled to the rim frame 42 in a bonding manner. As a result, the present invention can replace the conventional circuit board of the light emitting unit 381 by the rim frame 42 so as to save material cost of the circuit board, and thus manufacturing cost of the display device 34 can be decreased. In addition, because the light emitting unit 381 is disposed on the rim frame 42 directly, the heat generated from the light emitting unit 381 can be conducted from the rim frame 42 to the plurality of thermal fins 44 and then be dissipated to the surrounding environment via the plurality of thermal fins 44.

In summary, the invention uses the plurality of thermal fins 44 to increase heat-dissipating surfaces. That is, the plurality of thermal fins 44 are used for dissipating the heat generated by the light emitting unit 381 and conducted from the rim frame 42, so as to decrease the temperature of the backlight module 38 in operation effectively. The rim frame 42 and the plurality of thermal fins 44 can be made of metal material with high thermal conductivity, so that the thermal efficiency can be increased significantly. Therefore service life and luminous efficiency of the backlight module 38 are increased, and thus better utilization of the light source can be achieved.

In addition, the display device 34 further includes a fixing structure 46 for combining the rim frame 42 and the back cover 40. As shown in FIG. 2, the fixing structure 46 includes a first engaging structure 461, a frame 463 and a second engaging structure 465. The frame 463 is disposed between the back cover 40 and the rim frame 42, and the frame 463 is used for clamping the panel 36 cooperatively with the rim frame 42. The first engaging structure 461 is formed on the rim frame 42. The second engaging structure 465 is disposed on the frame 463 and is used for engaging with the first engaging structure 461, so as to fix the rim frame 42 and the back cover 40. In practical application, the first engaging structure 461 can be a slot, and the second engaging structure 465 can be a hook. However, the engaging mechanism of the fixing structure 46 is not limited to the above-mentioned embodiment. For example, the first engaging structure 461 can be a hole and the second engaging structure 465 can be a stud. An operator can use a screw screwing to the stud through the hole, so as to fix the rim frame 42 and the back cover 40.

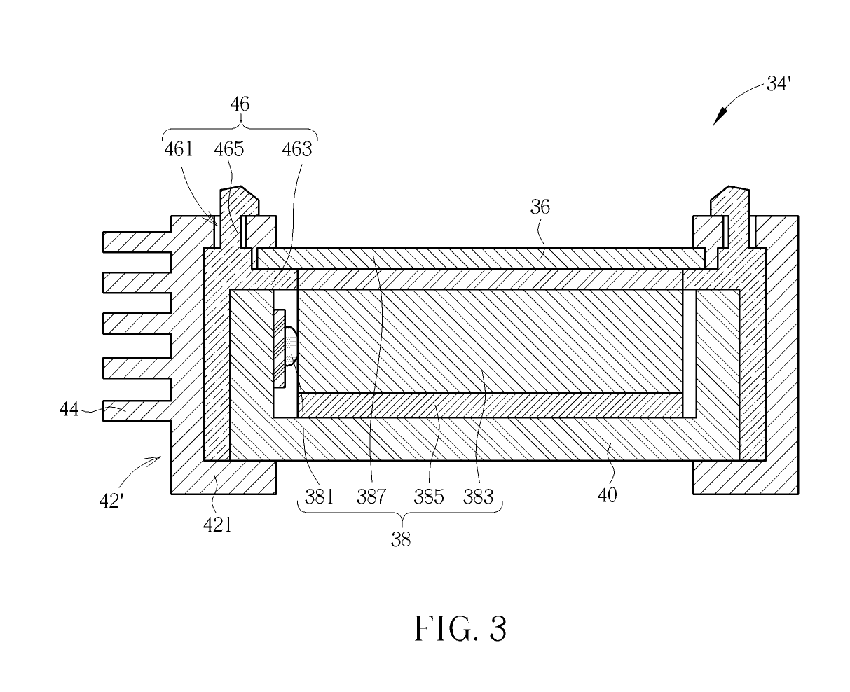

Please refer to FIG. 3. FIG. 3 is a sectional view of a display device 34′ according to another embodiment of the invention. As shown in FIG. 3 and FIG. 2, the main difference between the display device 34′ and the display device 34 is that the light emitting unit 381 of the display device 34′ is disposed on the back cover 40, and a rim frame 42′ has an extension portion 421. The extension portion 421 is used for connecting the back cover 40. Therefore, the back cover 40 can contact against the rim frame 42′ so that the heat generated from the light emitting unit 381 can be conducted through the back cover 40 and the extension portion 421 to the rim frame 42′, and then to the plurality of thermal fins 44. As a result, the heat generated from the light emitting unit 381 and conducted from the rim frame 42′ can be dissipated by the plurality of thermal fins 44, so as to decrease the temperature of the backlight module 38 in operation.

Furthermore, in this embodiment, the back cover 40, the rim frame 42′ and the plurality of thermal fins 44 can be made of metal material, and the circuit of the light emitting unit 381 can be disposed on the back cover 40. The light emitting unit 381 can be coupled to the back cover 40 in a bonding manner thereby. As a result, the present invention can replace the circuit board of the light emitting unit 381 by the back cover 40 so as to save material cost of the circuit board, and thus manufacturing cost of the display device 34′ can be decreased. It is mentioned that the components with the same numerals in FIG. 3 and FIG. 2 have the same structures and functions, and detailed description is omitted herein for simplicity.

In contrast to the prior art, the invention uses the plurality of thermal fins disposed on the rim frame to dissipate the heat generated from the light emitting unit. When the light emitting unit is coupled to the rim frame in a bonding manner, the heat generated from the light emitting unit can be dissipated through the rim frame and the thermal fins to the surrounding environment. In addition, when the light emitting unit is coupled to the back cover in a bonding manner, the back cover of the present invention contacts against the rim frame so that the heat generated from the light emitting unit can be dissipated through the back cover, the rim frame and the thermal fins to the surrounding environment. Therefore, the present invention can enhance the heat-dissipating efficiency so as to increase service life and luminous efficiency of the backlight module. In addition, the present invention can solve a problem of non-uniform brightness caused by deformation of the optical material layer due to poor heat dissipation and the overheating light source.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device comprising:
a panel;
a backlight module for providing the panel with a light source, the backlight module comprising:
a light emitting unit for emitting light; and
a light guide plate disposed below the panel for guiding the light emitted by the light emitting unit to the panel;
a back cover installed on an outer side of the panel and the backlight module;
a rim frame combining the back cover for covering the panel and the backlight module cooperatively with the back cover; and
a plurality of thermal fins disposed on the rim frame for dissipating heat conducted from the rim frame and generated by the light emitting unit.

2. The display device of claim 1, wherein the light emitting unit is coupled to the rim frame and disposed at a side of the light guide plate in a bonding manner.

3. The display device of claim 1, wherein the light emitting unit is disposed on the back cover, and the back cover contacts against the rim frame so that the heat generated by the light emitting unit is conducted from the back cover and the rim frame to the plurality of thermal fins.

4. The display device of claim 3, wherein the light emitting unit is coupled to the back cover in a bonding manner.

5. The display device of claim 3, wherein the back cover is made of metal material.

6. The display device of claim 1, further comprising a fixing structure for combining the rim frame and the back cover.

7. The display device of claim 6, wherein the fixing structure comprises:
a first engaging structure formed on the rim frame;
a frame disposed between the back cover and the rim frame; and
a second engaging structure disposed on the frame for engaging with the first engaging structure so as to fix the rim frame and the back cover.

8. The display device of claim 7, wherein the rim frame is made of metal material.

9. An electronic device comprising:
a host; and
a display device pivotally connected to the host, the display device comprising:
a panel;
a backlight module for providing the panel with a light source, the backlight module comprising:
a light emitting unit for emitting light; and
a light guide plate disposed below the panel for guiding the light emitted by the light emitting unit to the panel;
a back cover installed on an outer side of the panel and the backlight module;
a rim frame combining the back cover for covering the panel and the backlight module cooperatively with the back cover; and
a plurality of thermal fins disposed on the rim frame for dissipating heat conducted from the rim frame and generated by the light emitting unit.

10. The electronic device of claim 9, wherein the light emitting unit is coupled to the rim frame and disposed at a side of the light guide plate in a bonding manner.

11. The electronic device of claim 9, wherein the light emitting unit is disposed on the back cover, and the back cover contacts against the rim frame so that the heat generated by the light emitting unit is conducted from the back cover and the rim frame to the plurality of thermal fins.

12. The electronic device of claim 11, wherein the light emitting unit is coupled to the back cover in a bonding manner.

13. The electronic device of claim 12, wherein the back cover is made of metal material.

14. The electronic device of claim 9, further comprising a fixing structure for combining the rim frame and the back cover.

15. The electronic device of claim 14, wherein the fixing structure comprises:
a first engaging structure formed on the rim frame;
a frame disposed between the back cover and the rim frame; and
a second engaging structure disposed on the frame for engaging with the first engaging structure so as to fix the rim frame and the back cover.

16. The electronic device of claim 15, wherein the rim frame is made of metal material.
